(19) United States
(12) Patent Application Publication
(10) Pub. No.: US 2012/0090094 A1
(43) Pub. Date: Apr. 19, 2012

(54) Diaper Changing Pad With Reminder Indicia

(76) Inventor: Leisel Theresa Whitlock Petersen, San Leandro, CA (US)

(21) Appl. No.: 13/213,091

(22) Filed: Aug. 19, 2011

Related U.S. Application Data
(60) Provisional application No. 61/401,795, filed on Aug. 20, 2010.

(51) Int. Cl. A47D 13/08; B26D 7/27; G09F 3/00

(52) U.S. Cl. 5/655; 53/396

(57) ABSTRACT

A diaper changing pad includes a first fabric layer with a first side and a second fabric layer, the first fabric layer being fastened to the second fabric layer at least about an outside perimeter, the first side of the first fabric layer being opposite the second fabric layer. The first side of the first fabric layer has a plurality of markings disposed thereon, the plurality of markings including a first marking indicating diapers, a second marking indicating wipes, and a third marking indicating clothing. The first side of the first fabric layer is substantially flat.

### CROSS REFERENCE TO RELATED APPLICATION

This application claims priority to and claims the benefit of the filing date of U.S. Provisional Patent Application No. 61/401,795, filed on Aug. 20, 2010.

### BACKGROUND OF THE INVENTION

When leaving home with a baby or toddler, parents or other caregivers must remember to bring numerous items so that they are able to care for their child while on the road. New parents are generally sleep deprived and usually running late for engagements. Moreover, a new parent may never have had to gather a baby's items before becoming a parent and simply will not have the experience to rely on when in a harried state. Invariably, the parent is in a hurry trying to get everything together and get to his or her destination on time. Then, while out on the road, the parent realizes that he or she has forgotten one or more items, and must either return home, buy the item while out, or hope that the baby does not require the item until they return home.

It would be a great benefit to new and experienced parents alike to have a device that quickly and efficiently reminds them of each item that the baby needs when they are out of the house with the baby. It would be a particular great benefit if that device was something that they were required to bring with them when they left the house with the baby.

### BRIEF DESCRIPTION OF THE DRAWINGS

FIG. 1 is a plan view of a first example of a diaper changing pad with reminder indicia;

FIG. 2 is a section view taken along line II-II in FIG. 1.

FIG. 3 is an isometric view of a second example of a diaper changing pad with reminder indicia;

FIG. 4 is an isometric view of the second example of a diaper changing pad with baby gear disposed thereon;

FIG. 5 is a plan view of the back side of a third example of a diaper changing pad with reminder indicia.

FIG. 6 is a plan view of the front side of a third example of a diaper changing pad with reminder indicia;

FIG. 7 is a front view of the third example of the diaper changing pad in a folded state; and

FIG. 8 is a plan view of the front side of a fourth example of a diaper changing pad with reminder indicia.

### DETAILED DESCRIPTION

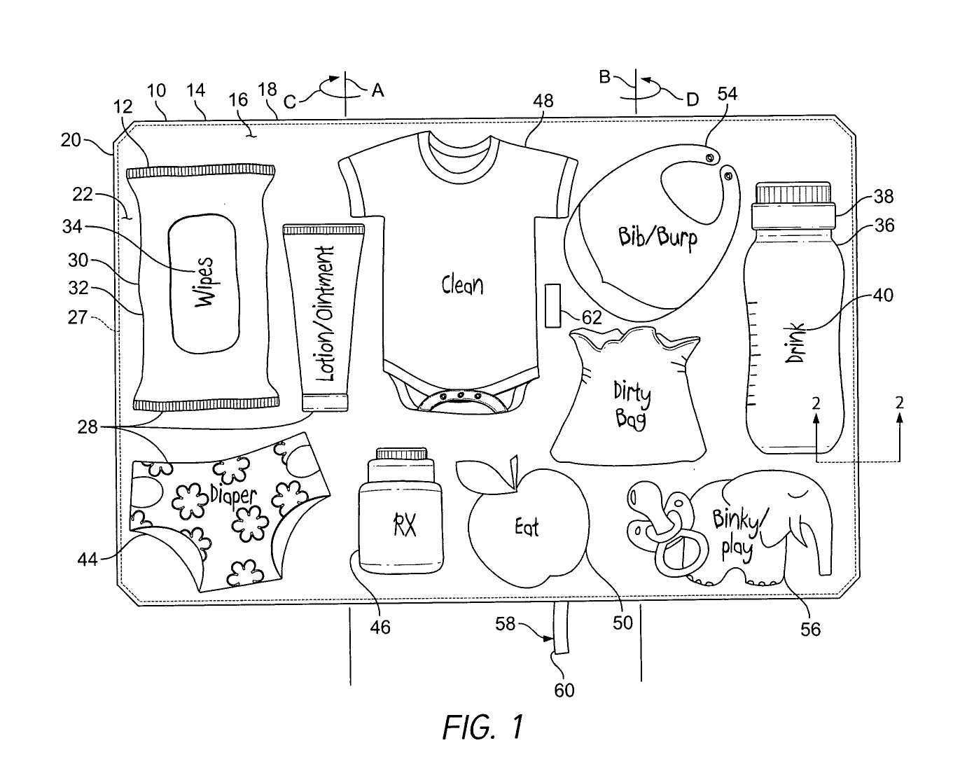

FIG. 1 depicts a diaper changing pad 10 with indicia 12 disposed thereon that can remind a parent of items that he or she should bring with to care for a child when out of the house. As is known, a changing pad is used by a parent while travelling out of the house. When changing a dirty diaper, the parent or other caregiver places the changing pad on a counter top or changing station, then places the child on the changing pad to change the child's soiled diaper. The changing pad protects child from any viruses, bacteria, dirt or other unwanted material disposed on a countertop or other surface on which he or she is placed. The changing pad 10 also protects the countertop surface from the soiled diaper.

The changing pad 10 includes a mat 14 having a first side 16 shown in FIG. 1 and second side 18 which is the side opposite the first side 16 and not shown in FIG. 1. The mat 14 includes the reminder indicia 12 disposed on the first side 16. The mat 14 has an outer perimeter 20.

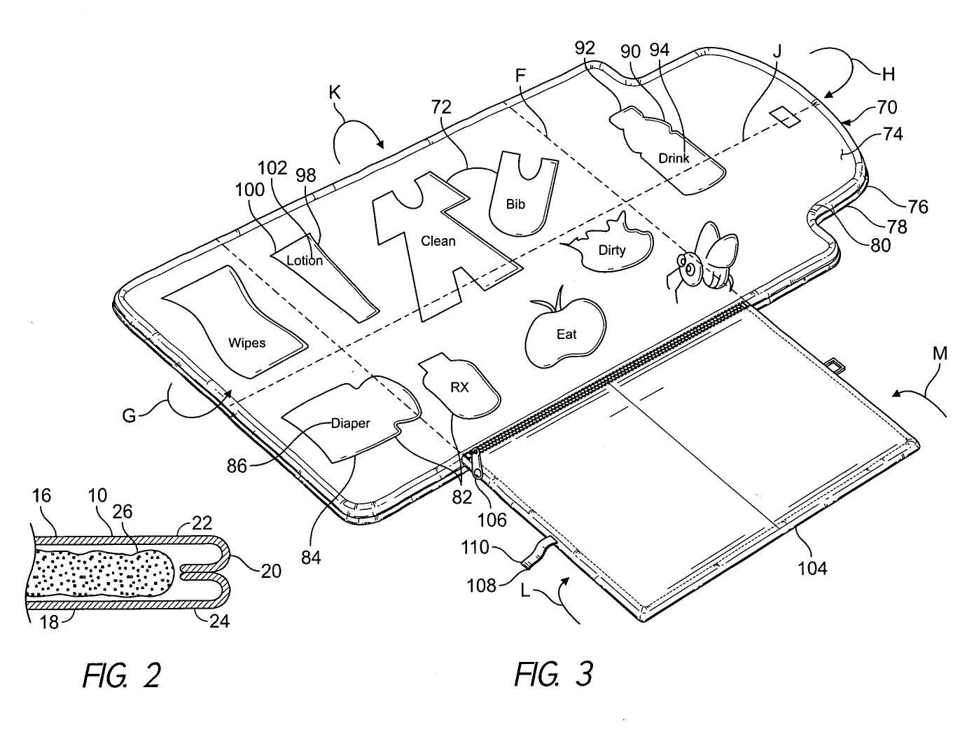

In the disclosed example, and shown most clearly in FIG. 2, the changing pad 10 is made from a first layer 22, a second layer 24, and a batting 26 disposed between the first layer 22 and the second layer 24. Of course, a single layer of fabric could be used, as could three or more layers. In this example, the first layer 22 is fastened to the second layer 24 about the outer perimeter 20 with a stitching 27. Other methods of attaching the first layer 22 to the second layer 24 will be seen by those of skill in the art. Although not shown, a decorative trim can be placed around the outer perimeter 20 of the changing pad 10. It should be noted that FIG. 2 depicts the first layer 22 and the second layer 24 just prior to being stitched together.

The first layer 22 can be any fabric, including a cotton linen blend, a cotton duck cloth, a polyester blend, or a sheet plastic. Of most importance is that the indicia 12 can be disposed on or applied to the first layer 22. The second layer 24, the side on which the baby is placed when changing a diaper, in this example is a water-repellant polyurethane laminate (PUL) to ensure that urine does not penetrate the changing pad and any matter can easily be wiped off the pad 10. The second fabric layer 24 of the changing pad can be made from other materials, such as neoprene, bamboo, cotton, fleece, hemp or thermoplastic elastomer, that are not as easy to clean if the parent so desires. Most importantly, the changing pad 10 acts as a barrier between the child and any potentially infectious surface, or between any delicate surface and a soiled child. The first side 16 of the first layer 22 is substantially flat due to it being a flexible fabric.

The changing pad 10 can be rectangular in shape, and be of such a size that an infant or toddler can lie thereon. This pad has an approximate width of 12-24 inches and an approximate length of 18-36 inches; preferably it is 16 inches wide by 24 inches high. The changing pad 10 should be sized so that a two year old boy with average height can fit on the changing pad 10. The changing pad 10 can also be circular or oval in shape having similar dimensions. Typically, the changing pad 10 is small enough to fold up or roll up and place in a handbag, but large enough for a toddler to lie upon.

The changing pad 10 also includes the indicia 12 disposed on the first layer 22. The indicia 12 include one or more markings 28 that can remind a parent of one or more important items that he or she should take when they bring the child away from home. In this example, the changing pad 10 includes a total of ten markings 28 representing items related to an infant and/or toddler that might be necessary to bring with on a trip outside the house with the child. A first marking 30 includes a first outline drawing 32 of a bag of wet wipes. Inside the first outline drawing 32 is a first label 34 that reads “Wipes”. This first marking 30 is a reminder to the parent to bring wipes. A second marking 36 includes a second outline drawing 38 of a bottle in which is written a second label 40 “Drink”. Again, this marking reminds the parent to bring a bottle or sippy cup from which the child can drink. The third through tenth markings include combinations of drawings and respective labels placed in the drawings of Lotion/Ointment 42, Diaper 44, Rx 46, Clean 48, Eat 50, Dirty Bag 52, Bib/Burb 54, and Binky/Play 56. These markings 28 make it readily apparent to the parent what he or she should bring. Other useful markings can be identified and placed on the changing pad 10. In this example, the markings take the shape of the item identified or otherwise include a drawing of the item and also includes a label in addition to the drawings. In other examples, only labels could be used, or only drawings could be used of some combination thereof. Here the labels are disposed inside the drawings, but that is not necessary; the labels can be outside the drawings as well.

The indicia 12 can be disposed on the first layer 22 in any known method. In this example, the indicia 12 are digitally printed onto the first layer 22. Other known methods can be used such as silk screening. The indicia 12 can also be embossed or sewn patches. One of ordinary skill will see other methods of applying or incorporating the indicia 12 to the first layer 22.

The changing pad 10 can include a hook and loop fastener system 58. The changing pad 10 can include a tab 60 extending outwardly from the outer perimeter 20. Disposed on the tab 60 is the hook portion of the fastener system 58. The changing pad 10 can also include a receiver 62 that forms the loop portion of the fastener system 58. The user can fold the pad over itself along axis A and axis B in the directions of arrows C and D. The user can then roll or fold the changing pad 10 over itself such that the tab 60 can be affixed to the receiver 62, and the changing pad 10 is minimized to a compact and portable unit.

In use, when preparing to leave the house with a baby or toddler, the parent will place the changing pad 10 on the kitchen table, counter top, or another similar surface with the first side 16 up. The parent will then place diapers on top of the diapers marking 44. The parent will then place the wipes on top of the wipes marking 30. The parent will continue the process by placing, for example, food on the Eat marking 50, drink such as a bottle on the Drink marking 36, an extra set of clothes on the Clean marking 48, and a rattle or other toy on the Binky/Play marking 56. The parent can continue the process with the remainder of the markings 28. If other markings 28 are disposed on the changing pad 10, the parent can place the item identified by the marking 28 on top of it.

Once the parent has gathered all of the items he or she needs and placed them all on the respective marking 28 identified on the changing pad 10, the parent can then place all the items into a travel bag, including the changing pad 10 itself. The parent can then leave the house with the infant confident that he or she has brought all items that he or she will need to take care of the infant while on the road.

FIG. 3 depicts a second example of a diaper changing pad 70 with reminder indicia 72. The second changing pad 70 includes two fabric layers 74, 76 connected at an outer perimeter 78 by stitching 80 similar to that shown in FIG. 1. The indicia also include markings 82 with drawings 84 and labels 86.

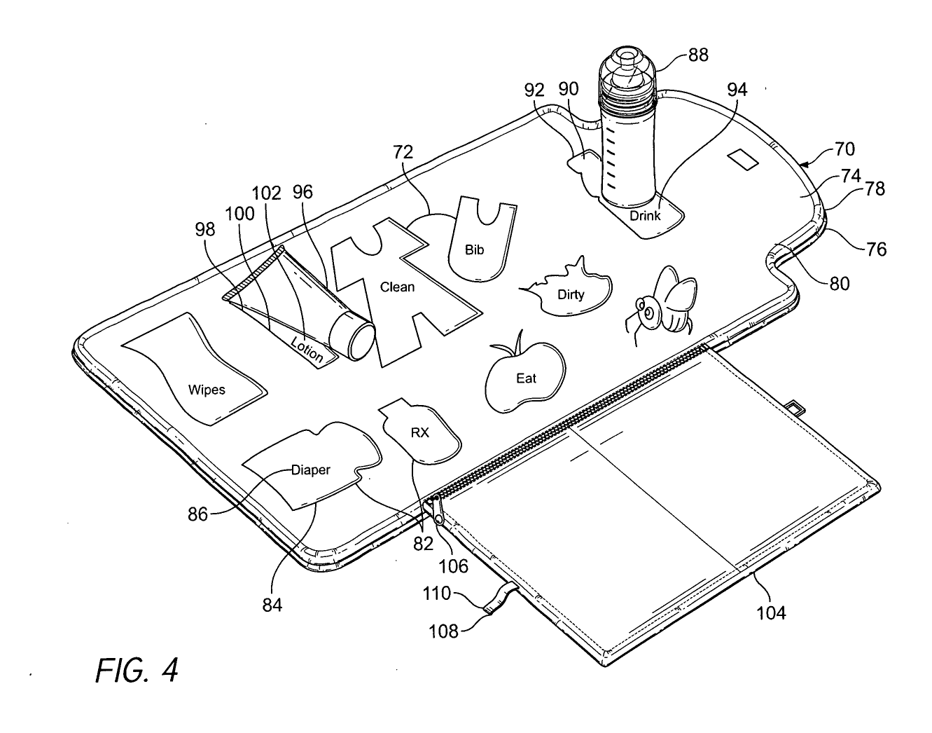

As shown in FIG. 4, the second diaper changing pad 70 is used in the same manner as the first. The user can place a bottle 88 onto a drink marking 90 having a bottle-shaped drawing 92 and a label 94 indicating “Drink.” The user can also place a tube of lotion 96 on top of a lotion marking 98 having a tube-shaped drawing 100 and a label 102 indicating “Lotion.” The user can continue this process until all needed items have been placed on top of the changing pad 70, and the user will then be sure that he or she has all items necessary to bring.

As shown in FIG. 3, in this example, the diaper changing pad 70 includes a case 104 for travel such that when the changing pad 70 is folded up, it can be protected. The case 104 is detachably connected to the changing pad 70. In this example, it is connected by a zipper 106, but other structure and methods of detachable connection can be used such as hook and loop fastener systems or snaps. The case 104 can be made of any material, including hard plastic, water resistant fabric, or other fabrics such as cotton or polyester.

To fold up the diaper pad 70, the user first folds the pad in thirds about axes E and F in directions G and H. The user then folds the changing pad 70 in half over itself about axis J in the direction of K. The user then folds the changing pad 70 into the cover 104, which then folds up in the direction of L and M. The user can fasten the case using the hook and loop fastener system 108 with the depicted tab 110 and the receiver (not shown).

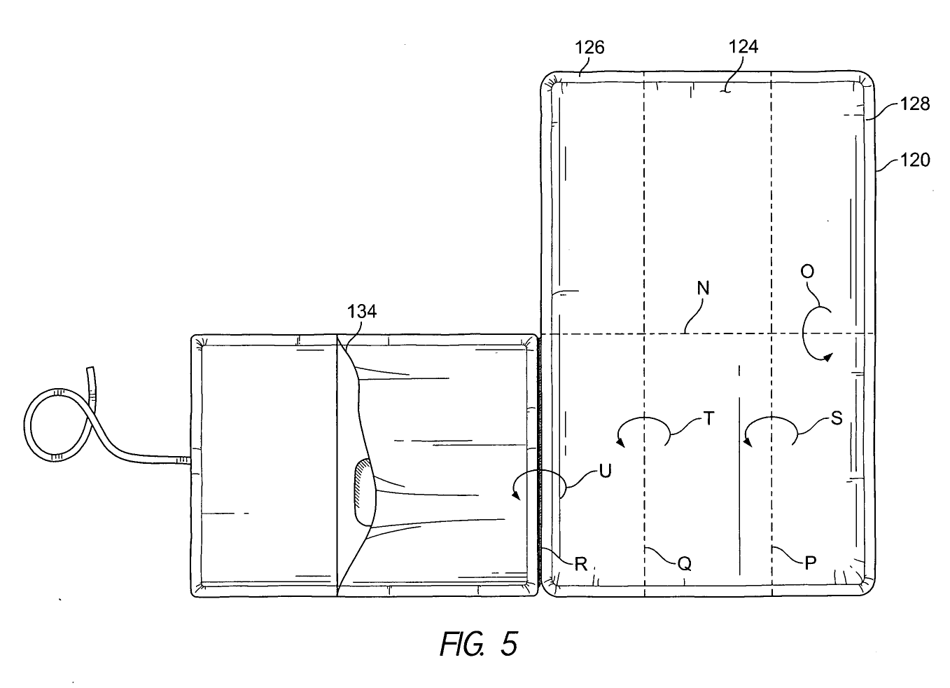

FIGS. 5-7 depict a third example of the diaper changing pad 120. The changing pad 120 includes a first layer 122 and a second layer 124 fastened together about an outer perimeter 126 with a stitching 128. The first layer 122 includes a set of indicia 130 similar to the first example.

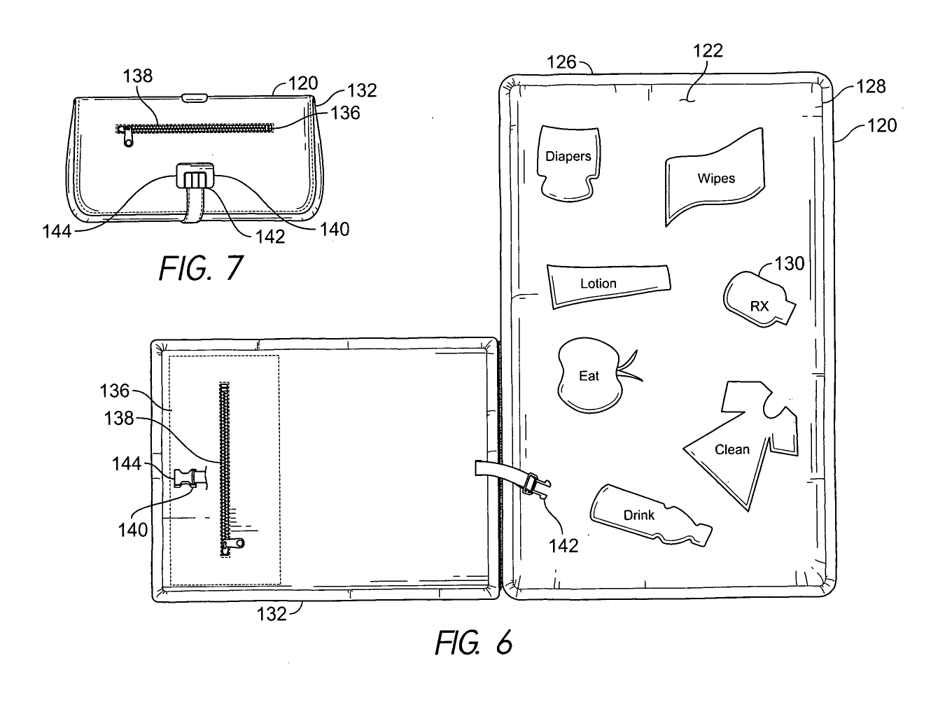

In this example, the changing pad 120 is connected to a case 132 that includes an interior pocket 134 and an exterior pocket 136. The exterior pocket 136 can be closeable by a zipper 138. The case 132 also includes a side-action buckle 140 to close the case, best seen in FIGS. 6 and 7.

To fold up the diaper changing pad 120, the user will fold the changing pad about axis N in the direction of 0. The user will then fold the changing pad sequentially about axes P, Q, and R in the directions of S, T, and U, respectively. The user can then fold the case over itself and insert a male portion 142 of the buckle 140 into a female portion 144 of the buckle 140 to snap it closed.

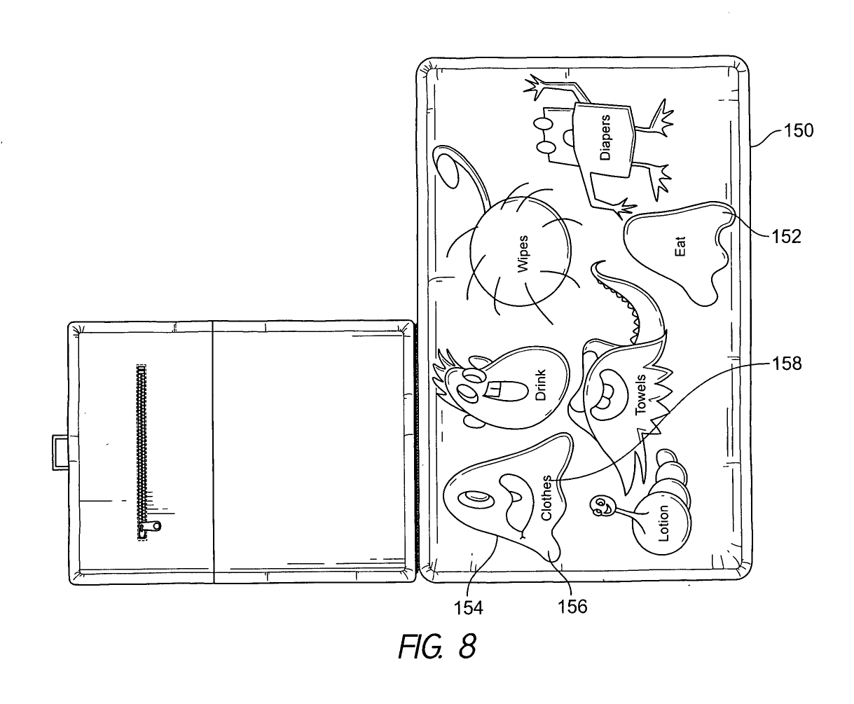

FIG. 8 depicts a fourth example of a diaper changing pad 150 with reminder indicia 152. In this example, the indicia 152 include markings 154 with drawings 156 and labels 158 as in the earlier examples. However, in this example, the drawings 156 are not indicative of the items that can be disposed thereon, but instead are decorative in nature. It is, in fact, solely the labels 158 that direct the user as to which items to place thereon.

The foregoing provides a description of a diaper changing pad with reminder indicia disposed or applied thereon. No limit shall be read into the description. To the contrary, all designs falling within the spirit and scope of the examples described herein are included.

I claim:

1. A diaper changing pad, comprising:
a first fabric layer with a first side; and
a second fabric layer, the first fabric layer being fastened to the second fabric layer at least about an outside perimeter, the first side of the first fabric layer being opposite the second fabric layer;
wherein the first side of the first fabric layer has a plurality of markings disposed thereon, the plurality of markings including a first marking indicating diapers, a second marking indicating wipes, and a third marking indicating clothing;
wherein the first side of the first fabric layer is substantially flat.

2. The pad of claim 1, further comprising a batting disposed between the first layer and the second layer

3. The pad of claim 1, the first marking comprising a drawing depicting a diaper.

4. The pad of claim 1, the first marking comprising a word label “diaper”.

5. The pad of claim 4, the first marking further comprising a drawing depicting a diaper.

6. The pad of claim 1, the second layer comprising a water-resistant fabric.

7. The pad of claim 7, the second layer comprising polyurethane laminate.

8. The pad of claim 1, the first layer comprising cotton, a cotton/polyester blend, or a plastic sheet.

9. The pad of claim 1, further comprising a case attached to the outer perimeter of the first layer and the second layer.

10. The pad of claim 9, wherein the case includes securing means for securing the case in a closed position.

11. The pad of claim 10, wherein the securing means is a side-action buckle, a hook and loop fastener system, or one or more snaps.

12. The changing pad of claim 1, wherein the pad has a width of between about 12-24 inches and a height of about 18-36 inches.

13. The changing pad of claim 12, wherein the pad has a width of 16 inches and a height of 24 inches.

14. The changing pad of claim 1, further including decorative trim disposed about the outer perimeter.

15. A method of packing a bag with items related to an infant, the method comprising:
providing a changing pad, the changing pad including a first fabric layer and a second fabric layer, the first fabric layer having a first side, the first fabric layer being fastened to the second fabric layer at least about an outside perimeter, the first side of the first fabric layer being opposite the second fabric layer; wherein the first side of the first fabric layer has a plurality of markings disposed thereon, the plurality of markings including a first marking indicating diapers, a second marking indicating wipes, and a third marking indicating clothing; wherein the first side of the first fabric layer is substantially flat;
placing a diaper on the first marking;
placing a wipe on the second marking;
placing clothing on the third marking; and
placing the diaper, wipe, clothing, and changing pad in a bag separate from the changing pad.

16. The method of claim 15, the changing pad including a case attached to its outer perimeter, the method including folding the first and second layers into the case, and folding the case about the first and second layers and fastening the case closed.
